(19) United States
(12) Patent Application Publication
(10) Pub. No.: US 2008/0034206 A1
(43) Pub. Date: Feb. 7, 2008

(54) Encryption Method

(76) Inventor: Dimitri Korobkov, Frankfurt/Main (DE)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 10/598,832

(22) PCT Filed: Aug. 15, 2005
(86) PCT No.: PCT/EP05/54004

§ 371 Date: Sep. 13, 2006

(30) Foreign Application Priority Data
Aug. 17, 2004 (DE) 10 2004 039 899.2

(51) Int. Cl. H04L 9/12

(52) U.S. Cl. 713/162

(57) ABSTRACT

The present invention relates to a method for encrypting digital information using communication devices, which have an interface for a replaceable or writable storage medium, whose content may be read out and duplicated, having a storage medium which is connected to the interface, a supply of symbols for encryption being stored on the digital storage medium, which may be read out on the basis of an address, having an encryption unit which employs the supply of symbols for encrypting and/or decrypting the digital data stream of the communication device on the basis of at least one address.

### FIELD OF THE INVENTION

The present invention relates to a device and a method for encrypting a digital communication. In particular, the present invention relates to a method for providing keys in a symmetrical encryption method.

### BACKGROUND OF THE INVENTION

According to Shannon [1, 2], the security of an encryption system may be represented as the conditional entropy of the unencrypted data sequence, in the event of a known encrypted data sequence.

The conditional entropy may, at most, be as large as the length of the random key sequence (crypto sequence) [3].

As a result, theoretical complete encryption may only be achieved if the key sequence is at least as large as the data sequence.

For this purpose, the crypto sequence is random, having equally probable symbols, and has the same length as the data sequence (plaintext). Every crypto sequence is only used one single time (one time pad).

The disadvantage of this approach is that complete encryption requires a very long key length.

In practice, until now, a pseudorandom crypto sequence has been generated using an encryption machine (cipher). To generate the pseudorandom crypto sequence, the initial status of the encryption machine and a key sequence are necessary. The initial status and key sequence must be known during both encryption and decryption. Typically, the key sequence is much shorter than the pseudorandom crypto sequence generated therefrom.

### SUMMARY OF THE INVENTION

The object of the present invention is to provide a method and a device which allows the most optimum possible encryption for a communication, such as a mobile communication.

This object is achieved by the present invention through the features of the independent claims. Advantageous refinements of the present invention are characterized in the subclaims.

In the method according to the present invention, the random crypto sequence is not generated in an encryption machine, but rather taken from a supply of equally probable symbols, which preferably were stored in a flash EPROM or are stored on a flash card and/or a flash memory. Other small memory modules which are insensitive and may be used in portable communication devices are also conceivable, such as minidisks or very small hard drives. Holographic memories or nanomemory elements are also conceivable, if they may be used in mobile devices. Since it is a symmetrical method, the content of the flash EPROM is to be identical for encryption and decryption. Therefore, two copies of the flash EPROM are prepared for the communication of two devices. If even more users are to participate in the communication (e.g., police radio), appropriately many copies are to be provided.

The supply of random crypto sequence taken from the storage medium has the same length as the data sequence to be encrypted. Therefore, the theoretical complete encryption according to Shannon is achieved.

The initial address of the crypto sequence taken is to be known for the encryption and decryption.

In the related art, and therefore in conventional methods, the encryption and decryption are synchronized by transmitting the initial status of the encryption machine (cipher).

In the method according to the present invention, which has access to a large flash memory, for example, the initial address of the read operation is transmitted for the synchronization.

With sequential processing of the flash content, the initial address identifies the boundary between used and unused crypto sequence.

In a further embodiment, instead of reading out the flash content sequentially, reading out pseudorandom addresses may be performed. The pseudorandom addresses are generated in a pseudorandom generator (PRG) on the basis of an initial status and a key. Multiple uses of the flash content are made possible, but may also be avoided in the individual case.

In a further embodiment of the method, the initial status of the pseudorandom generator (PRG) is also transmitted to synchronize the encryption and decryption.

In a further embodiment, the “fire and forget” method, information is transmitted in blocks without considering preceding blocks.

The receiver must be capable of synchronizing and reconstructing the information on the basis of a single received block.

In the conventional method, for this purpose, the status of the cipher must also be transmitted in every block in a preamble. Typically, the redundancy necessary for this purpose is very high.

In the method according to the present invention, the status of the pseudorandom generator is also transmitted in every block in a preamble. Typically, the redundancy necessary for this purpose is much lower.

In yet a further embodiment, instead of sequentially reading out the flash content, pseudorandom addresses may be read out. The pseudorandom addresses are generated in a pseudorandom generator (PRG) on the basis of an initial status and a key. Multiple uses of the flash content are made possible.

For this purpose, the status of the PRG is transmitted instead of the address for synchronization.

In a further alternative embodiment, a permutation of the data is additionally performed in order to conceal the positions of the synchronizing information (status of the PRG).

### BRIEF DESCRIPTION OF THE DRAWINGS

In the following, the present invention will be explained in greater detail on the basis of exemplary embodiments which are schematically illustrated in the figures. Identical reference numbers in individual figures identify identical elements in this case.

FIGS. 1a, 1b and 1c show a symmetrical encryption on the basis of the mod2 operation, a cipher generating the random crypto sequence and synchronization being performed on the basis of the initial status of the cipher;

FIGS. 2a, 2b and 2c show the method based on the present invention, the symbols from the flash EPROM being used to perform an encryption; for this purpose, the initial address is transmitted as the initial status, in order to then finally shift this address to the front, so that a used region and an unused region arise;

FIGS. 3a and 3b show the method according to the present invention in an alternative embodiment, the address, from which the symbol is to be read from the storage medium flash EPROM, being determined by a pseudorandom generator (PRG), whose status is initially transmitted;

FIGS. 4a and 4b show alterations of the method from FIGS. 1 and 3, synchronization information of the cipher and/or the PRG being transmitted at regular intervals;

FIG. 5 shows the data stream in a preferred embodiment which performs an encryption;

FIG. 6 shows the data stream in a preferred embodiment which performs a decryption of the data encrypted in FIG. 5.

### DETAILED DESCRIPTION OF THE PREFERRED EMBODIMENTS:

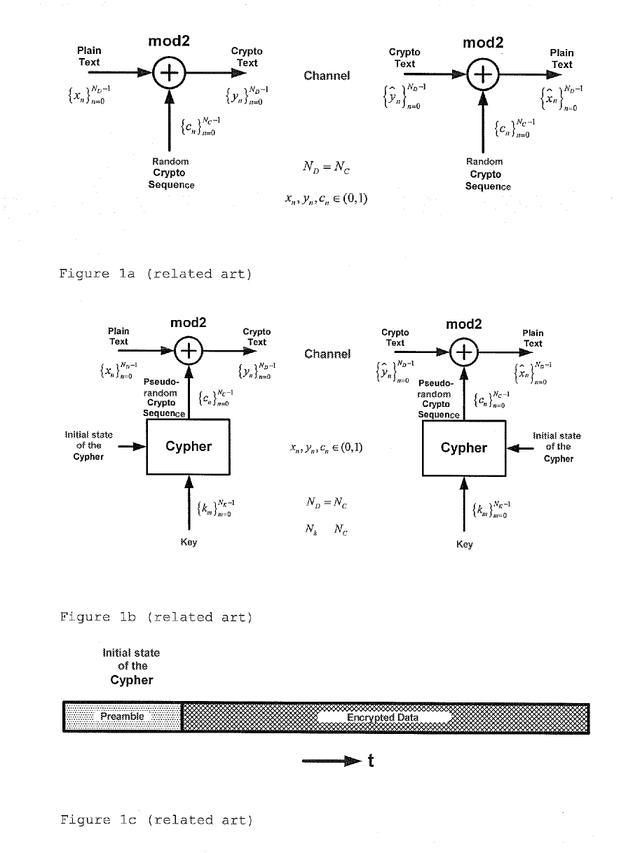

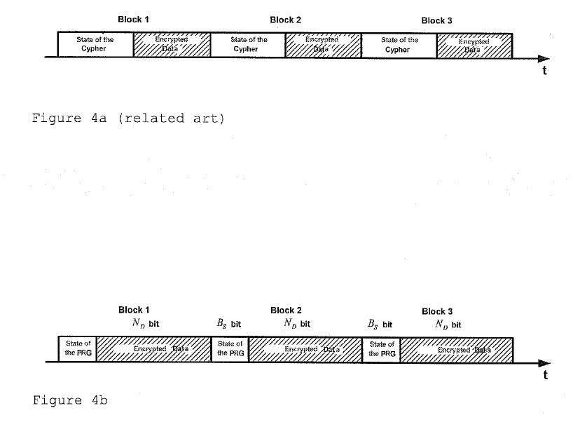

As already noted in the introduction, FIGS. 1a through 1c describe a method as is known from the related art. A cipher (random generator) generates a sequence for this purpose, using which the data is encrypted through a mod2 operation. Since the cipher is deterministic, the future data sequence may be determined on the basis of the status, through which transmission of the initial status is possible or, as may be seen from FIG. 4a, repeated transmission of the status allows synchronization.

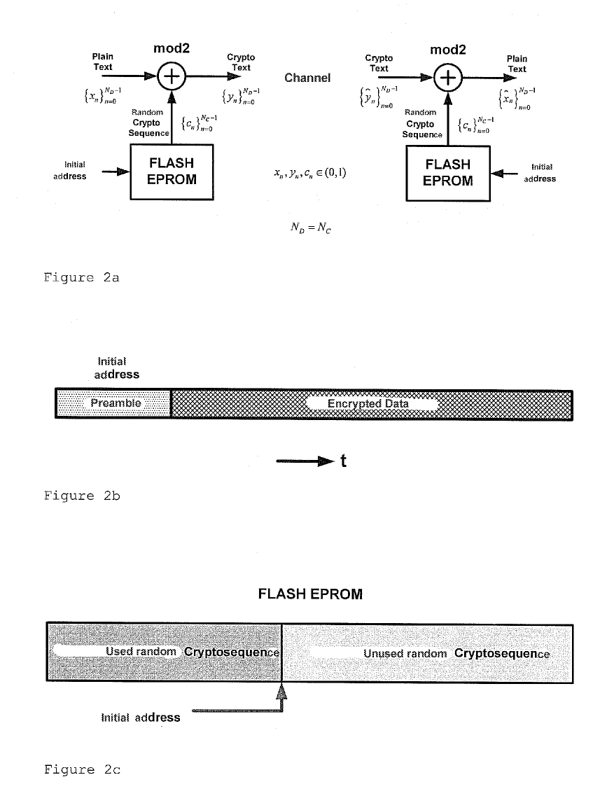

The embodiment according to the present invention may be inferred from FIGS. 2a through 2c. For this purpose, the symbols for encryption are not generated by a random generator, but rather are stored in a memory. A complete data stream may thus be encrypted on the basis of the size of the flash memory. Instead of the status of the cipher, the address on the storage medium is transmitted.

In the following, an example of the duration of the encrypted transmission time as a function of the flash size is shown. A flash EPROM of the size N_{c}=2³³ bit=2 GByte is provided. L_{C}=33 bit is necessary for addressing this memory size.

It is assumed digitized speech information is transmitted at a data rate R_{VC}=2400 bit/s, as is the case in the GSM field or a digital radio, for example, thus, with a single readout of the entire flash content (OTP: one time pad), i.e., without reusing individual segments, a total duration of

$${T}_{OTP} = \frac{{N}_{c}}{{R}_{VC}} = 994.2$$

### Hours=41,4 Days

may be transmitted encrypted. Since this is a net time for this purpose, a storage medium is usable for encryption for more than one month with secure encryption. Only then are the storage media of all users to be rewritten and/or initialized.

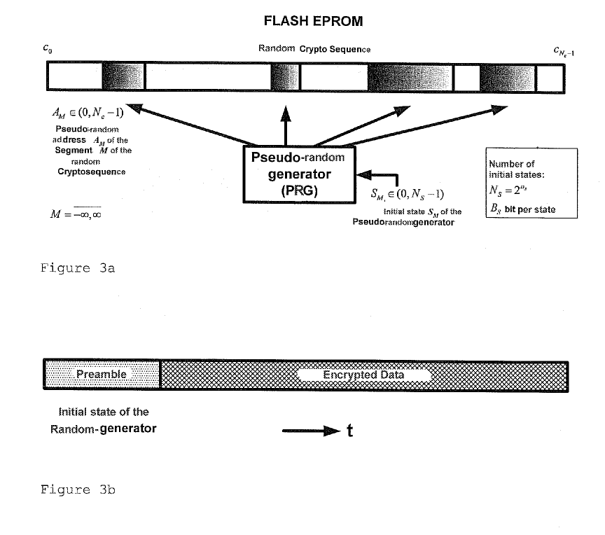

FIG. 3 shows a further embodiment of the present invention. In this approach, a random generator generates the address for the memory card. Instead of transmitting the initial address of the card or the current address (FIG. 4b), the status of the PRG is transmitted. Thus, even if a card is lost, eavesdropping is not immediately possible, since the random generator does not determine the address linearly. For synchronization, as may be seen from FIG. 4b, the status of the random generator is transmitted again and again.

If one assumes that a vocoder assembles the symbols to be transmitted into frames of a duration of 20 ms and the data rate of the vocoder is R_{VC}=2000 bit/s, ND=40 bits are transmitted in a frame. BS=14 bits are available for transmitting the synchronization information. It results from this that N_{S}=2^{B,}=16384 segments of the crypto sequence having a length of 40 bits each may be addressed. This corresponds to the number of statuses of the pseudorandom generator.

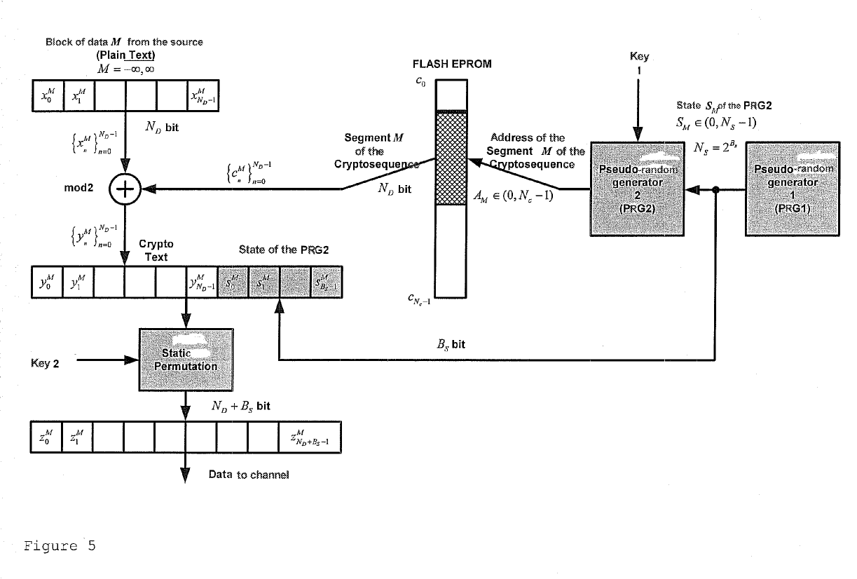

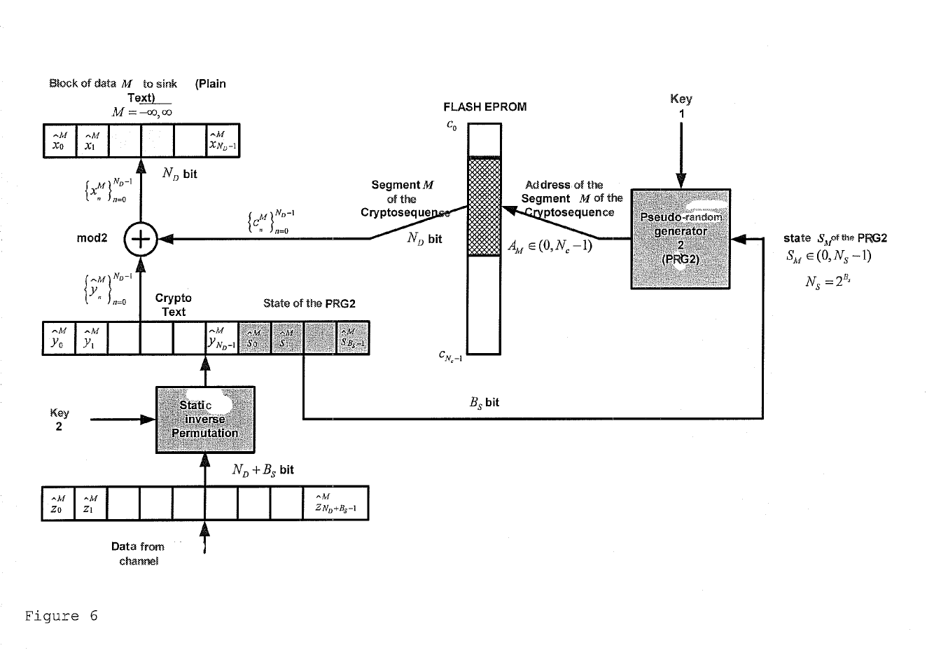

FIGS. 5 and 6 show a further embodiment of the present invention. In addition to the permutations of the information before it is transmitted, a second random generator (PRG1) is used. PRG1 is used to scramble the access to individual segments of the crypto sequence if PRG2 determines the concrete addresses of the above-mentioned segments. The status of the first random generator is stored in the crypto text precisely like the encrypted information which was encrypted using the symbols at the address of the region determined by the PRG2. During the decryption, the random generator is synchronized on the basis of the transmitted status in order to then read out the correct segment from the specific address of the memory card, on the basis of which the back transformation occurs. Subsequently, the permutation is canceled out.

### List of the Cited Literature:

[1] C. E. Shannon, A mathematical theory of communication, Bell Syst. Tech. J. , vol. 27., Part1. pp. 379-423, Part 2. pp. 623-656, 1948.

[2] C. E. Shannon, Communication theory of secrecy systems, Bell Syst. Tech. J., vol. 28., pp. 565-715, 1949.

[3] J. L. Massey, An introduction to contemporary cryptology, Proc. IEEE, vol. 76, pp. 533-549, May 1988.

1. A method for encrypting digital information comprising the following steps:
using communication devices which have an interface for a replaceable or writable storage medium, whose content may be read out and duplicated,
using a storage medium which is connected to the interface, a supply of symbols for encryption being stored on the digital storage medium which may be read out on the basis of an address,
using an encryption unit which employs the supply of symbols for encrypting or decrypting the digital data stream of the communication devices on the basis of at least one address.

2. The method according to claim 1, wherein the symbols on the storage medium are only used once and are thus “used up”.

3. The method according to claim 1, wherein the symbols are encrypted and decrypted with the data stream using mod2.

4. The method according to claim 1, wherein the mobile terminal comprises one or more of the following: a radio device, laptop, PDA, a mobile telephone having an interface for a memory card that is insensitive and may be used in portable communication devices.

5. The method according to claim 1, wherein the storage medium is one or more of the following: a flash memory card, a hard drive, an optical storage drive, whose information may be addressed.

6. The method according to claim 1, wherein the addresses of the symbols to be used on the storage medium are transmitted to synchronize the encryption.

7. The method according to claim 6, wherein the addresses are transmitted at specific intervals to synchronize the encryption.

8. The method according to claim 1, wherein there is a first random generator (PRG2) on the communication device which determines the address on the storage medium.

9. The method according to claim 8, wherein the status of the random generator is transmitted to synchronize the encryption.

10. The method according to claim 8, wherein there is a second random generator (PRG1) which performs scrambling of the access to individual segments if PRG2 determines the concrete addresses of the segments.

11. The method according to claim 1, wherein a permutation of the digital data is performed before it is transmitted.

12. The method according to claim 1, wherein the storage medium is written by the noise of an analog source using an A/D converter.

13. A communication device which encrypts a digital data stream,
having an interface for a replaceable or writable storage medium, whose content may be read out and duplicated, a supply of symbols for encryption, which may be read by using an address, being stored on the storage medium, which may be connected to the interface,
having an encryption unit, which is set up so that it uses the supply of symbols for encrypting or decrypting the digital data stream of the communication devices by accessing this supply through addresses.

14. The communication device according to the preceding communication device claim 13, comprising a device which uses the symbols on the storage medium only once.

15. The communication device according to claim 13, comprising a computer which encrypts or decrypts the symbols with the data stream using mod2.

16. The communication device according to the preceding communication device claim 13, wherein it is one or more of the following: a radio device, laptop, PDA, or a mobile telephone having an interface for a memory card, the memory card being insensitive and usable in portable communication devices.

17. The communication device according to claim 13, wherein the storage medium is one or more of the following: a flash memory card, a hard drive, an optical storage drive
whose information may be addressed.

18. The communication device according to claim 13, comprising means which transmit the addresses of the symbols to be used on the storage medium for synchronizing the encryption.

19. The communication device according to the preceding claim 18, comprising means which transmit the address at specific intervals to synchronize the encryption.

20. The communication device according to claim 13, wherein there is a first random generator (PRG2) on the communication device which determines the address on the storage medium.

21. The communication device according to the preceding claim 20, wherein the status of the random generator is transmitted to synchronize the encryption.

22. The communication device according to the preceding claim 21, comprising means, through which the status of the random generator is transmitted at specific intervals.

23. The communication device according to claim 20, wherein there is a second random generator (PRG1), which scrambles the access to individual segments if PRG2 determines the concrete addresses of the segments.

24. The communication device claim 13, comprising means which perform a permutation of the digital data before the data is transmitted.

25. The communication device according to claim 13, wherein the storage medium is written by the noise of an analog source using an A/D converter.

26. A use of a mobile addressed memory element, such as a flash card, which is readable by a mobile communication device, for storing symbols for encryption, the symbols being able to be addressed.

27. (canceled)

28. A data carrier for a computer, comprising a data structure for storing instructions for a computer for executing the method according to claim 1.

29. A computer system having a communication interface, comprising a device which allows the execution of a method according to method claim 1.
